(19) United States
(12) Patent Application Publication
(10) Pub. No.: US 2024/0217134 A1
(43) Pub. Date: Jul. 4, 2024

(54) WOOD SUBSTRATE WITH A FLAME-RETARDANT FINISH

(71) Applicant: LUFTHANSA TECHNIK AG, Hamburg (DE)

(72) Inventors: Moritz Reifferscheid, Basedow (DE); Matthias Schultz, Bad Bramstedt (DE)

(21) Appl. No.: 18/557,596

(22) PCT Filed: Apr. 29, 2022
(86) PCT No.: PCT/EP2022/061529

§ 371 Date: Oct. 27, 2023

(30) Foreign Application Priority Data
Apr. 29, 2021 (DE) 10 2021 111 074.2

(51) Int. Cl. B27K 3/34; B05D 7/00; B27K 3/15; C08K 5/00; C08K 5/17; C08L 63/10; C09D 5/18; C09D 7/20; C09D 163/10

(52) U.S. Cl. CPC B27K 3/34; B05D 7/53; B27K 3/15; C08K 5/0066; C08K 5/17; C08L 63/10; C09D 5/18; C09D 7/20; C09D 163/10; B05D 2203/20; B05D 2320/00; B05D 2504/00; B27K 2240/30; C08L 2201/02

(57) ABSTRACT

A flame-retardant wood substrate is made of a wood substrate with a glass-clear coating, impregnation, or filing primer, which each contain a flame retardant made of at least one compound selected from a plurality of phosphorus compounds, and a finish layer disposed thereon.

### CROSS REFERENCE TO RELATED APPLICATIONS

This application is a U.S. National Phase application under 35 U.S.C. § 371 of International Application No. PCT/EP2022/061529, filed on Apr. 29, 2022, and claims benefit to German Patent Application No. DE 10 2021 111 074.2, filed on Apr. 29, 2021. The International Application was published in German on Nov. 3, 2022 as WO 2022/229410 A2 under PCT Article 21(2).

### FIELD

The present disclosure relates to a flame-retardant wood substrate and to a method for producing it.

### BACKGROUND

Interior spaces are often fitted out using paneling, furniture or the like having wood surfaces, especially wood veneers. The wood surfaces are intended to play a part in improving the appearance of the surface, and the wood surfaces, and particularly the veneers, require protection from mechanical exposures. In some cases, this can be achieved by means of a coating on the veneer. In certain cases, such a coating also serves to improve the fire protection.

For example, when installing furniture or paneling in the interior of an aircraft, there are a traffic law requirements to be met with regard to the fire performance. A component of this kind is exposed to a flame with a temperature of 860° C. for 60 s in a Bunsen burner fire test, for example. When the source of the flame is removed, the component must extinguish within 15 s. The distance between the site of application of the flame and the burned site on the sample surface that is at the greatest distance from the flame must not be more than 150 mm (FAA CS 25.853 (a)).

From common prior usage, there are wood surfaces known that have glass-clear finishes, bearing polyurethane finishes or polyester finishes. To reduce the fire properties of the substrate, a flame-retardant impregnation is oftentimes additionally used (such as, e.g., disclosed in DE102010054341B3 and DE102013202493A1). One known means of achieving this is to provide the wood directly with a flame-retardant impregnation. A disadvantage of this is that such an impregnation may discolor the wood and in certain circumstances acts as a plasticizer in a subsequently applied clearcoat layer. Moreover, the adhesion of a finish layer on the impregnated surface may be adversely affected. Additionally known from common prior usage is the provision of clearcoat with chemical fire protection agents. Here again, a disadvantage is that the wood surface may suffer discoloration and the flame retardants may act undesirably as plasticizers.

The fire-inhibiting properties of the known finish systems are not always sufficient to provide the wood surfaces with adequate protection. Impregnations in the wood adversely affect the quality of the surfaces, either directly or indirectly. One example of a direct adverse effect is the formation of a milky surface due to fire protection salts that have crystallized out. One example of an indirect adverse effect is a greatly increased subsidence of finish or aging of finish owing to chemically unbound flame retardant in the substrate, which slowly migrates through the overlying finish layers and accelerates the aging due to substrate/finish layer interactions.

### SUMMARY

In an embodiment, the present disclosure provides a flame-retardant wood substrate made of a wood substrate with a glass-clear coating, impregnation, or filling primer, which each contain a flame retardant made of at least one compound selected from a plurality of phosphorus compounds, and a finish layer disposed thereon.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows schematically a flame-retardant wood substrate implemented according to aspects of the present disclosure; and

FIG. 2 shows schematically a flame-retardant wood substrate implemented according to aspects of the present disclosure.

### DETAILED DESCRIPTION

Aspects of the present disclosure provide a flame-retardant wood substrate and a method for producing such a substrate, each of which makes it possible to combine good surface properties of wood surfaces on the substrate that have a glass-clear finish with good fire protection. Aspects of the present disclosure are directed overcoming the disadvantages of the prior art as elucidated above.

In an advantageous embodiment implemented according to aspects of the present disclosure, a flame-retardant wood substrate is provided, characterized in that, the wood substrate bears a glass-clear coating, impregnation and/or filling primer with a flame retardant containing at least one compound selected from phosphorus compounds, and a finish layer disposed thereon.

A number of terms used in the context of the present disclosure are elucidated below.

A wood substrate comprises, for example, an item of furniture, wall paneling or the like. The substrate may be made from solid wood or, preferably, may consist of a wood veneer on a supporting structure. The supporting structure may be chipboard, a sandwich structure or the like. The woods that are used may comprise, for example, maple, anigre, oak, macassar, palisander, redwood, and wenge.

A mixture provided according to aspects of the present disclosure may be applied in the form of a coating, impregnation, and/or filling primer or pore filler to the substrate. A coating stays substantially on the surface, whereas an impregnation involves complete or partial penetration of cell walls, pores, and other interstices of the substrate. A filling primer or pore filler involves the pores of the wood being completely filled or closed. In the present disclosure, the composition applied may also comprise a hybrid form composed of coating, impregnation, and/or filling primer. The properties of the mixtures applied on the substrate may be altered, for example, by different degrees of dilution. In highly diluted form, the mixture works preferably as a flame-retardant impregnation. In weakly diluted form, the mixture serves preferably as a flame-retardant primer-filler.

The concept of a “glass-clear” coating, impregnation, filling primer, or layer is understood in the context of the present disclosure to refer to a coating, impregnation, filling primer, or layer that is see-through and unclouded, thus being transparent in the true sense, so that there is virtually no visual alteration when the underlying substrate surface is viewed.

The glass-clear coating, impregnation, and/or filling primer with flame retardant preferably further comprises at least one curing agent and/or at least one binder.

The curing agent is preferably selected from amino curing agents, polyamine curing agents and mixtures thereof.

The binder is preferably selected from epoxy resins. It preferably comprises a glass-clear epoxy resin. However, epoxy resins which are glass-clear only after drying or curing of the coating, impregnation and/or filling primer may also be used. The epoxy resin is preferably an epoxy resin based on bisphenol A. The epoxy resin is preferably an unfilled epoxy resin.

The flame retardant of the present disclosure preferably comprises a glass-clear flame retardant. However, the flame retardant may also contain phosphorus compounds which are glass-clear only after drying or curing of the coating, impregnation and/or filling primer.

The flame retardant containing the phosphorus compound preferably comprises a reactive flame retardant. With a reactive flame retardant, at least one, two, or more, or all of the compounds used in the flame retardant is or are itself or themselves a constituent of the material used for the coating, impregnating and/or primer-filler material. This may be accomplished in particular through polymerization. In the case of additive flame retardants, conversely, the fire-retarding compounds are incorporated merely as an adjuvant, but without undergoing chemical reaction with other constituents of the composition.

The phosphorus compounds contained in the flame retardant preferably comprise organic phosphorus compounds. The flame retardant is preferably halogen-free.

The flame retardant comprising the phosphorus compound preferably has an epoxide functionality. It preferably comprises an epoxide-equivalent flame retardant based on phosphorus. It may, moreover, have a broad epoxide compatibility.

The flame retardant preferably comprises a liquid, low-viscosity flame retardant. The viscosity of the flame retardant is preferably less than 150 Pa*s, more preferably less than 100 Pa*s, more preferably still less than 50 Pa*s (measured at 80° C., 20 s−1). The density of the flame retardant is preferably 1.1 to 1.3 g/³ m, more preferably 1.15 to 1.25 g/³ m, measured via pycnometer at a temperature of 20° C.

The flame retardant implemented according to an aspect of the present disclosure with particular preference comprises a liquid, halogen-free, preferably low-viscosity flame retardant based on organic phosphorus compounds with epoxide functionality. It comprises highly effective flame retardants which have good processing qualities and in the event of fire have little or no toxicity. Where the flame retardant is of low viscosity, it may also be processed in solvent-free form.

The epoxide equivalent weight of the flame retardant is preferably at most 600 g/mol, more preferably at most 550 g/mol, more preferably still at most 500 g/mol, measured according to DIN 16945:1989-03. The epoxide equivalent weight is a metric of compounds which contain epoxide groups. The epoxide equivalent weight describes the mass in grams which contains one mole of epoxide groups.

A mass fraction of the flame retardant in the uncured resin material containing flame retardant and binder may be from 20 to 99 weight %, more preferably from 20 to 50 weight %, based on the total mass of flame retardant and binder in the uncured resin material for the coating, impregnation and/or filling primer. In an alternative embodiment, in which there is preferably 100 weight % of the flame retardant, the flame retardant is used without carrier resin. In that case, though, a curing agent must be added for curing the flame retardant.

The flame retardant or a mixture comprising binder and flame retardant for producing the coating, impregnation and/or filling primer present on the wood substrate preferably has a viscosity of 5 to 100 s, more preferably 5 to 60 s, more preferably still 5 to 30 s, measured according to DIN EN ISO 2431 with 4 mm DIN cup. Where the flame retardant or the mixture is applied in highly diluted form to the substrate surface, it works preferably as a flame-retardant impregnation. The viscosity in that case is preferably 5 to 15 s, more preferably about 10 s. Where the flame retardant or the mixture is applied in weakly diluted form to the substrate surface, it works preferably as a flame-retardant primer-filler or pore filler. The viscosity in that case is preferably 20 to 30 s, more preferably about 25 s.

For producing the coating, impregnation and/or filling primer present on the wood substrate, the flame retardant or a mixture comprising flame retardant and binder is preferably applied to the substrate surface. The flame retardant or a mixture of flame retardant and binder, for producing the coating, impregnation and/or filling primer present on the wood substrate, may be admixed with a diluent, preferably selected from xylene, acetone and mixtures thereof. This diluent serves preferably to adjust the viscosity.

In an implementation according to aspects of the present disclosure, a finish layer is disposed on the impregnated, filled-and-primed, and/or coated substrate. This means that the finish layer may be applied directly to the impregnated, filled-and-primed, and/or coated substrate, or one or more interlayers may be disposed between the impregnated, filled-and-primed, and/or coated substrate and the finish layer. In one preferred embodiment, the finish layer is applied directly to the impregnated, filled-and-primed, and/or coated substrate.

The finish layer may comprise a topcoat or a clearcoat. A clearcoat in the present disclosure is a transparent finish which is see-through and unclouded, so that there is no visible alteration when the underlying substrate surface is viewed. Comprised preferably is the finish layer selected from the group consisting of polyurethane coatings, thioisocyanate coatings, polyester coatings, poly(meth)acrylate coatings, and epoxy coatings. These are coatings that are used in the prior art to coat wood and wood veneer surfaces in particular. The finishes may have any desired filling and coloring or else may be transparent finish systems. In the present disclosure, the finish may be admixed with solvents and/or a further flame retardant in order to increase the overall flame resistance.

In the case of polyurethane coatings, curing takes place by reaction of polyisocyanates with hydroxyl-containing compounds. The hydroxyl component may comprise, for example, polyesters, polyethers, or acrylic resins. Polyester coatings typically cure through polyaddition of unsaturated compounds. The same is true of poly(meth)acrylates. Suitable coatings are described for example in Ullmann's Encyclopedia of Industrial Chemistry, 6th edition, volume 24, page 594 ff. (Paints and Coatings) and also volume 39, page 515 ff. (Wood, surface treatment) specifically for wood surfaces. The cited disclosure is made part of the present application as well.

The embodiments implemented according to present disclosure have the advantage that, through the flame-retardant wood substrate of the present disclosure, it is possible to provide wood substrates having glass-clearly finished wood surfaces of very good surface quality that in addition meet exacting flame retardance requirements. The use in the present disclosure of the flame retardant containing phosphorus compounds, which are used preferably in glass-clear form, allows glass-clearly finished wood surfaces to be produced. This means that the resulting substrate surface is glass-clear and the wood color is not clouded, for example, due to the flame retardant used or due to other substances, such as curing agents or binders. A further advantage is that the phosphorus compounds used as flame retardants are cured by the curing agent or bound chemically by the epoxy resin used as binder, so that the flame retardant is unable to interact with the wood substrate or with the overlying finish layer or interlayer.

A further subject of the present disclosure is a method for producing a wood substrate of the present disclosure, which may include the steps as follows:
a. applying a curable flame retardant or a mixture composed of a flame retardant containing at least one compound selected from phosphorus compounds and of a binder selected from epoxy resins to the substrate surface, with a glass-clear coating, impregnation and/or filling primer being provided on the substrate surface; and
b. disposing a finish layer on the substrate surface furnished with the coating, impregnation and/or filling primer.

The disposing in step b. means in the context of the present disclosure that the finish layer may be applied directly to the impregnated, filled-and-primed, and/or coated substrate or one or more interlayers may be disposed between the impregnated, filled-and-primed, and/or coated substrate and the finish layer. In one preferred embodiment the finish layer is applied directly to the substrate surface furnished with the coating, impregnation and/or filling primer.

The curable flame retardant or the mixture comprising binder and flame retardant from step a. is applied preferably by a method selected from the group consisting of laying on, spraying on, unpressurized immersion and pressure impregnation.

The wood thus treated may be used in the form of veneers or in the form of solid wood. In air travel, the wood is generally used in the form of veneer and, in order to save weight, is combined with lightweight construction materials (sandwich materials made of outer plies of GRP or CRP and of a core of honeycomb material, or of any other type). However, there is no intention that the application be restricted thereto. Other conceivable applications are the furniture industry (solid lumber and veneer), yacht construction and boat construction (furniture and floors made of solid lumber or of veneered materials), rail vehicles, and others.

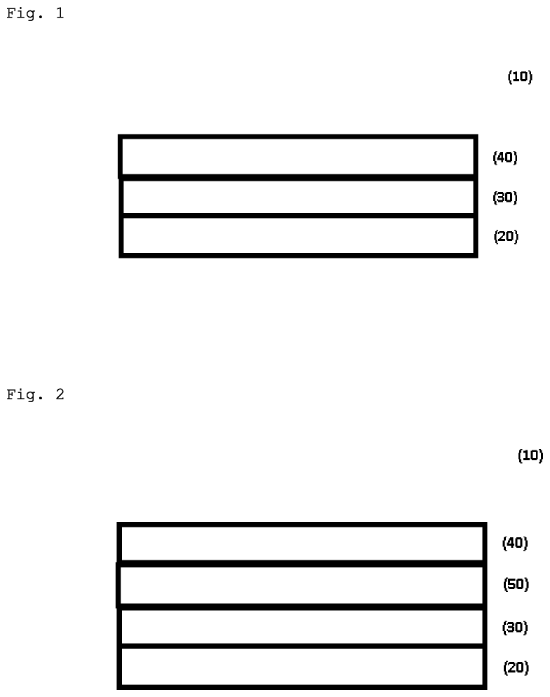

FIG. 1 shows schematically a flame-retardant wood substrate (10) of the present disclosure, where the wood substrate (20) bears a glass-clear coating, impregnation and/or filling primer (30) with a flame retardant containing at least one phosphorus compound and with a binder selected from epoxy resins, and also bears a finish layer (40) applied directly thereto.

The wood substrate used may be a solid lumber or a veneer. The wood used may comprise, for example, maple, anigre, oak, macassar, palisander, redwood and wenge.

The wood substrate (20) may bear a glass-clear impregnation (30) with a flame retardant selected from a phosphorus compound and with a binder selected from epoxy resins.

The impregnation produced may comprise, for example, a mixture of 50 weight % of epoxy resin with a polyamine curing agent and 50 weight % of a flame retardant based on phosphorus compounds with an epoxide equivalent weight of max. 550 g/mol and with xylene as diluent. The viscosity of such an impregnation is 10 s. The impregnation may be applied to the wood substrate by spray application.

Alternatively, the mixture recited as impregnation may be used as a pore filler, with a higher viscosity of 25 s. The pore filler may be applied to the wood substrate by knifing and/or spraying.

Clearcoats or topcoats may be employed as finish layer (40). As an alternative it is also possible to use the mixture recited above as a pore filler as a topcoat, in which case acetone rather than xylene is used as diluent and the flow/stretch characteristics of the mixture must be tailored to its processing as a topcoat. In this way, the topcoat layer is able to exhibit an additional flame-retardant effect. A topcoat of this kind may be sprayed on.

FIG. 2 shows schematically a flame-retardant wood substrate (10) of the present disclosure, where an optional interlayer (50) is disposed between the glass-clear coating, impregnation and/or filling primer (30) present on the wood substrate (20), and the finish layer (40). To generate higher layer thicknesses, photocuring systems, for example, may be used as an interlayer, in which case a flame retardant may additionally be added optionally to the photocuring system. The interlayer may be laid on by spray application and cured by subsequent exposure to light.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A flame-retardant wood substrate, comprising a wood substrate with a glass-clear coating, impregnation, or filling primer each comprising a flame retardant comprising at least one compound selected from a plurality of phosphorus compounds, and a finish layer disposed thereon.

2. The wood substrate as claimed in claim 1, wherein the class-clear coating, the impregnation, or the filling primer comprising the flame retardant further comprises at least one curing agent or at least one binder.

3. The wood substrate as claimed in claim 1, wherein the curing agent is selected from amino curing agents, polyamine curing agents, and mixtures thereof.

4. The wood substrate as claimed in claim 1, wherein the binder is selected from epoxy resins.

5. The wood substrate as claimed in claim 1, wherein the flame retardant is a reactive flame retardant.

6. The wood substrate as claimed in claim 1, wherein the flame retardant comprises at least one compound selected from a plurality of organic phosphorus compounds and the flame retardant is halogen-free.

7. The wood substrate as claimed in claim 1, wherein the flame retardant comprises a liquid, halogen-free, low-viscosity flame retardant based on phosphorus compounds with epoxide functionality.

8. The wood substrate as claimed in claim 1, wherein a mass fraction of the flame retardant in the uncured resin material comprising the flame retardant and a binder is from 20 to 99 weight %, based on the total mass of flame retardant and binder in the uncured resin material for the coating, impregnation, or filling primer.

9. The wood substrate as claimed in claim 1, wherein the flame retardant or a mixture comprising a binder and the flame retardant for producing the coating, impregnation, and/or filling primer present on the substrate has a viscosity of 5 to 100 s as measured according to DIN EN ISO 2431 with 4 mm cup.

10. The wood substrate as claimed in claim 1, wherein the flame retardant or the mixture serves in highly diluted form as flame-retarding impregnation, the flame-retarding impregnation preferably having a viscosity of 5 to 15 s.

11. The wood substrate as claimed in claim 9, wherein the flame retardant or the mixture serves in weakly diluted form as flame-retarding primer-filler, the flame-retarding primer-filler having a viscosity of 20 to 30 s.

12. The wood substrate as claimed in claim 1, wherein the flame retardant or a mixture of flame retardant and a binder for producing the coating, impregnation, or filling primer present on the wood substrate is admixed with a diluent, selected from xylene, acetone, and mixtures thereof.

13. The wood substrate as claimed in claim 1, wherein the finish layer is a topcoat or a clearcoat and the finish layer comprises coatings selected from the group consisting of polyurethane coatings, thioisocyanate coatings, polyester coatings, poly(meth)acrylate coatings, and epoxy coatings.

14. A method for producing a wood substrate as claimed in claim 1, the method comprising:
a. applying a curable flame retardant or a mixture comprising a flame retardant comprising at least one compound selected from a plurality of phosphorus compounds and a binder selected from a plurality of epoxy resins to a substrate surface, with a glass-clear coating, impregnation, or filling primer being provided on the substrate surface; and
b. disposing a finish layer on the substrate surface furnished with the coating, impregnation, or filling primer.

15. The method as claimed in claim 14, wherein the curable flame retardant or the mixture comprising a binder and the flame retardant is applied by a method selected from the group consisting of laying on, spraying on, unpressurized immersion, and pressure impregnation.

16. The wood substrate as claimed in claim 4, wherein the binder is selected from epoxy resins based on bisphenol A.
